(19) United States
(12) Patent Application Publication
(10) Pub. No.: US 2012/0096270 A1
(43) Pub. Date: Apr. 19, 2012

(54) END-TO-END NETWORK SECURITY WITH TRAFFIC VISIBILITY

(76) Inventors: Men Long, Hillsboro, OR (US); Jesse Walker, Portland, OR (US); David Durham, Beaverton, OR (US); Marc Millier, Banks, OR (US); Karavir Grewal, Hillsboro, OR (US); Prashant Dewan, Hillsboro, OR (US); Uday Savagaonkar, Beaverton, OR (US); Steven D. Williams, Portland, OR (US)

(21) Appl. No.: 13/337,919

(22) Filed: Dec. 27, 2011

Related U.S. Application Data
(62) Division of application No. 11/935,783, filed on Nov. 6, 2007.

(51) Int. Cl. H04L 9/32

(52) U.S. Cl. 713/171

(57) ABSTRACT

End-to-end security between clients and a server, and traffic visibility to intermediate network devices, achieved through combined mode, single pass encryption and authentication using two keys is disclosed. In various embodiments, a combined encryption-authentication unit includes a cipher unit and an authentication unit coupled in parallel to the cipher unit, and generates an authentication tag using an authentication key in parallel with the generation of the cipher text using an encryption key, where the authentication and encryption key have different key values. In various embodiments, the cipher unit operates in AES counter mode, and the authentication unit operates in parallel, in AES-GMAC mode Using a two key, single pass combined mode algorithm preserves network performance using a limited number of HW gates, while allowing an intermediate device access to the encryption key for deciphering the data, without providing that device the ability to compromise data integrity, which is preserved between the end to end devices.

### TECHNICAL FIELD

This application relates to the fields of communication and networking, and in particular, to maintaining end-to-end security between clients and a server, while allowing traffic visibility to intermediate network devices.

### BACKGROUND

Many network security protocols depend on negotiating session keys between clients and servers using expensive asymmetric cryptography and then requiring servers to keep track of a large number of symmetric keys negotiated for each client session. End-to-end security means that there is data authenticity and/or confidentiality of data from one side of a communication in the network all the way to the other side, e.g., client-to-server and server-to-client. Traffic visibility means that intermediate servers and information technology (IT) monitoring devices can view the secured traffic. To some degree, these two goals oppose one another, but both are important for network security in managed environments, where authorized intermediate devices need access to the data for performing valuable network functions such as security scanning for virus/worms.

End-to-end security is important for both clients and servers in order to exclude third parties from tampering with traffic between the client and server, where the client is the most exposed to direct manipulation or tampering. Thus, the uniqueness of the client's secrets (cryptographic keys) is paramount to prevent the compromise of one client from gaining access to the traffic of other clients. Traffic visibility is vital to the IT administration and requires the IT administration devices to observe traffic to detect abnormal phenomenon. Many current major security protocols only provide end-to-end security without concern for traffic visibility.

Recently, for efficiency, the industry has been moving towards single-key combined mode cipher (e.g. AES-GCM and AES-CCM) for both packet encryption and authentication. Resultantly, intermediate network devices having the single-key potentially can compromise the security aspect of network traffic authenticity in terms of end-to-end security. In other words, attackers who are successful in compromising an intermediate network device can freely spoof any legitimate packets that would be accepted by endpoints of clients and server. [AES Advanced Encryption Standard; GCM Galois Counter Mode; CCM=Counter CBC-MAC; and CBC-MAC=Cipher Block Chain Message Authentication Code.]

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 is an enterprise network security diagram in accordance with various embodiments of the present invention;

FIG. 2 is a depiction of a sequence on a client platform in accordance with various embodiments;

FIG. 3 is another client platform sequence in accordance with various embodiments;

FIG. 4 is a server sequence in accordance with various embodiments;

FIG. 5 is another sequence in accordance with various embodiments;

FIG. 6 is a hardware depiction in accordance with various embodiments; and

FIG. 7 depicts the Crypto engine of FIG. 6 in further details, in accordance with various embodiments.

### DETAILED DESCRIPTION OF ILLUSTRATIVE EMBODIMENTS

Illustrative embodiments of the present invention include, but are not limited to, methods and apparatuses for maintaining end-to-end security between clients and a server, while allowing traffic visibility to intermediate network devices. The intermediate network devices are unlikely to be able to fabricate or forge messages to spoof either the clients and/or the server, even if they are compromised by adversaries.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. in other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent in particular, these operations need not he performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

Embodiments of the present invention provide a security protocol that enables both end-to-end security between clients and sever, and traffic visibility for intermediate network devices, employing single-pass combined encryption-authentication with two keys, an encryption key and an authentication key, having different key values. Hardware-based, wire speed end-to-end encryption and authentication may be achieved on a frame-by-frame basis or a packet-by-packet basis. For the purpose of this application, the terms “frame” and “packet” may be considered interchangeable, unless the context clearly indicates otherwise. In various embodiments, clients and server communicate with a domain controller that grants the encryption and authentication keys, one set for each client-server relationship. Upon receipt of the encryption and authentication keys, a client and server pair uses them for combined encryption-authentication and for combined authentication-decryption. For traffic visibility without compromise authentication, the domain controller may also send the encryption keys (hut not the authentication key) to authorized IT network devices, such as, for example, an IT monitoring device/host. With the authorized IT network devices having the encryption keys, the authorized IT network devices are able to decrypt the encrypted pass-thru traffic at full wire speed, thus, enabling traffic visibility by the authorized IT network appliances. However, without the authentication keys, the IT network devices are unable to substitute authentications, and therefore unable to spoof the clients and server.

In various embodiments, the single-pass dual-key combined encryption-authentication mechanism may be practiced with a storage saving derived key mechanism. An example of a derived key mechanism may be seen in U.S. application Ser. No. 11/731,562, entitled “End-to-End Network Security with Traffic Visibility”, filed Mar. 20, 2007.

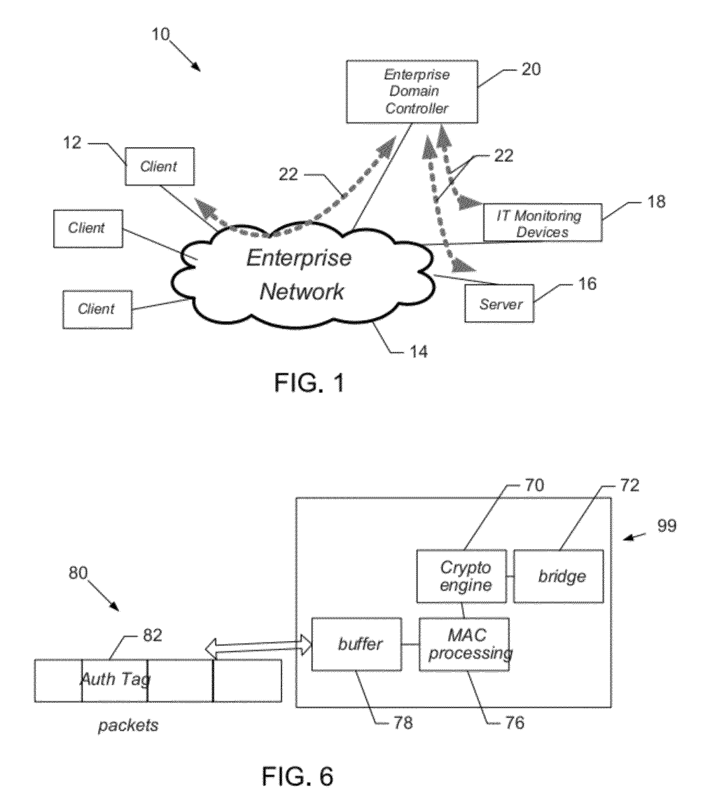

Referring to FIG. 1, an enterprise network 14 may be leveraged to communicate a plurality of clients 12 with one or more servers 16. For the illustrated embodiments, an enterprise domain controller 20 may be responsible for maintaining both end-to-end security for the entire enterprise and for maintaining traffic visibility for the server 16 and the IT monitoring devices 18. The domain controller 20 may be, for example, an authentication, authorization, and auditing (AAA) server, a key distribution server, or a policy server, to mention a few examples.

The enterprise domain controller 20 distributes the encryption and authentication keys (as indicated by arrows 22) to clients 12 and server 16. Additionally, the enterprise domain controller 20 also distributes the encryption keys (but not the authentication keys) to IT network monitoring host 18. As used herein the term “keys” include both the pre derived or fully derived forms. In other words, as alluded to earlier, domain controller 20 may distribute the encryption and authentication keys “fully derived”, or may practice a storage saving “derive key” mechanism, and distribute these keys pre-derived to authorized devices such as application servers and intermediate IT devices. In various embodiments, the domain controller always distributes derived keys to the clients, as clients are considered more vulnerable to attacks and hence compromising any pre-derived keys.

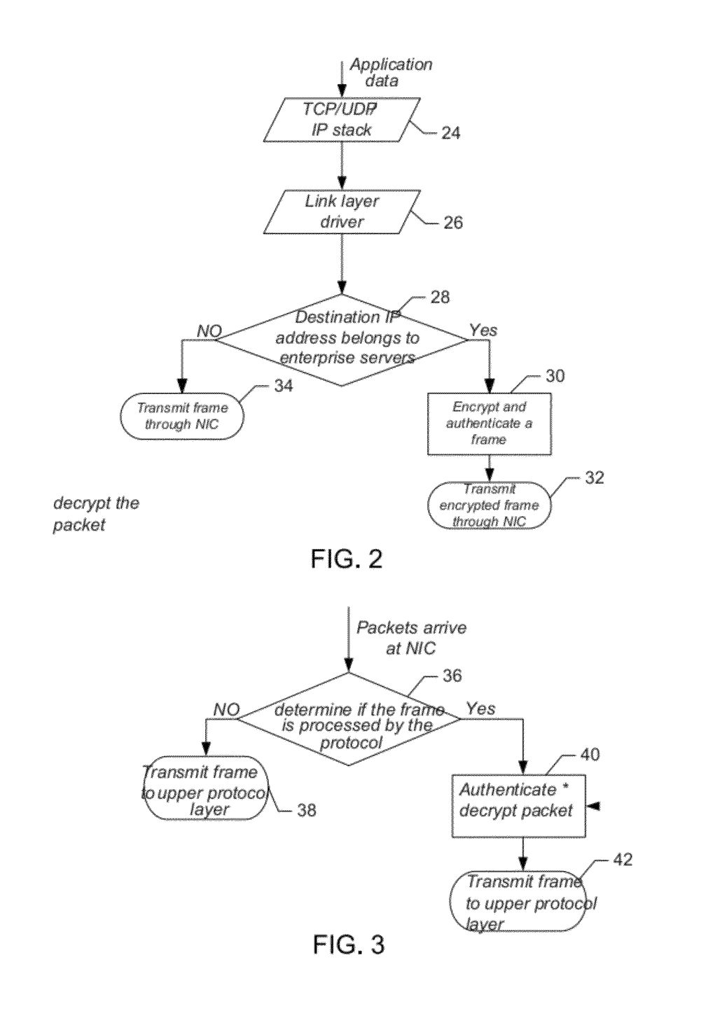

Referring to FIG. 2, a sequence of a client applying the encryption and authentication keys distributed by the domain controller 20 is depicted. Each of the outgoing frames to an enterprise server is encrypted and authenticated in a single-pass using the two received keys, the encryption key and the authentication key. Initially, application data comes into a Transmission Control Protocol (TCP)/User Datagram Protocol (UDP)/Internet Protocol (IP) stack as indicated at 24. The Internet Protocol packets are distributed to a server by the stack. Then the link layer driver forms the layer-2 frame, as indicated at 26. A check at diamond 28 determines whether the destination Internet Protocol address belongs to enterprise servers, if not, the frame is transmitted through a network interface card as indicated at 34. If so, the frame is encrypted and authenticated, as indicated at 30, in a single-pass using the appropriate encryption and authentication keys stored in hardware. Then the encrypted frame is transmitted through the network interface

When a client platform receives a frame, indicated as packets arrive at network interface card, a check at diamond 36, in FIG. 3, determines if the frame is processed by the protocol described herein. If not, the frame is transmitted to an upper protocol layer, as indicated at 38, and, if so, the packet is authenticated using the authentication key. And upon successful authentication, the packet is decrypted using the appropriate encryption key stored in hardware as indicated at Hock 40. The frame is then transmitted to the upper protocol layer as indicated at 42.

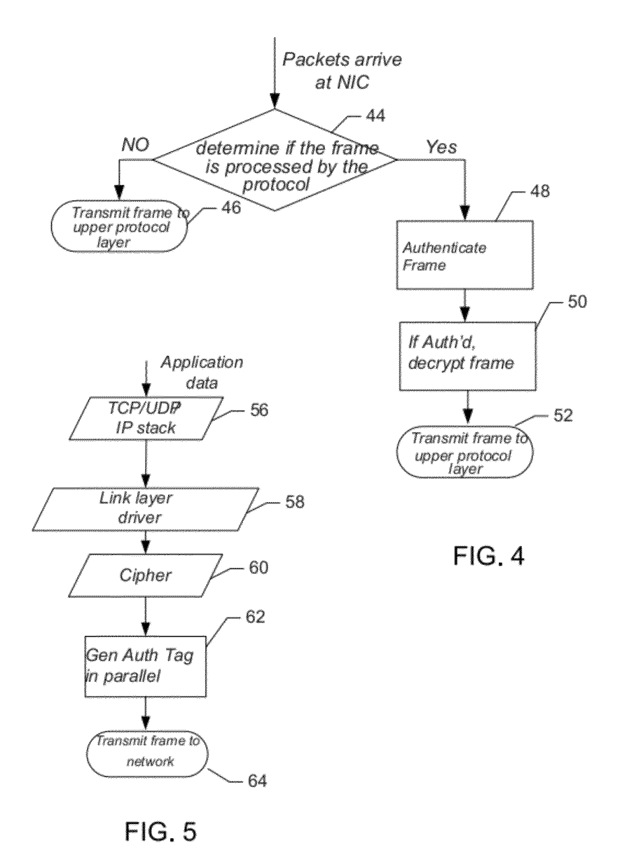

Next, referring to FIG. 4, when the server 16 receives a frame, indicated as packets arriving in a network interface card, a check at diamond 44 determines if the frame is processed by the protocol described herein. If not, the frame is transmitted to the upper protocol layer as indicated at 46. If so, the appropriate authentication key is (derived and) used to authenticate the received frame at 48. On authentication, the frame is decrypted at clock 50 by using the encryption key. Finally, the frame is transmitted to an upper protocol layer at 52.

The server may transmit a frame using the sequence shown in FIG. 5. Application data is received in the Internet Protocol stack at 56. The packets are to be distributed to various clients. A link layer driver then receives a frame at 58. At blocks 60 and 62, the appropriate encryption and authentication keys are applied to a single-pass dual-key algorithm to cipher the packet and generate an authentication tag in parallel. Finally, at 64, the frame is transmitted to the network.

The IT network monitoring devices 18 (FIG. 1) operate similarly to the server 12. The server 12 and the monitoring host 18 directly or derivatively maintain the keys to handle many different security associations from clients. An adversary compromising one client host is not able to impersonate another client because the keys for distinct clients/sessions are different and independent. For the domain controller 20, the server 16, and monitoring devices 18, since the number of keys is relatively small when practiced with the derived key mechanism, the keys can be stored in hardware, while still providing proper protection for tamper resistance.

In one embodiment, a frame format may piggyback the Internet Protocol security (IPSEC) frames.

In embodiments, both end-to-end security and traffic visibility for an enterprise network are provided. The mechanism may be implemented entirely in hardware, in some embodiments, which achieves full wire speed performance at lower cost in some cases.

Referring to FIG. 6, the hardware solution 99 includes a combined encryption-authentication block labeled as cryptographic engine 70 coupled to a bridge 72 and a MAC processing unit 76. The bridge 72 may include a direct memory access module (not shown). The processing unit 76 communicates with incoming and outgoing packets 80 through a buffer 78. The packets 80 may include the authentication tag (T) 82. For clients 12 and server 16, processing unit 76 is provided with both the encryption and authentication keys, but for intermediate network devices 18, processing unit is provided with only the encryption key, allowing the devices to have visibility to the traffic, but unlikely to be able to fabricate or forge messages to spoof the clients/server in the event the intermediate devices are compromised.

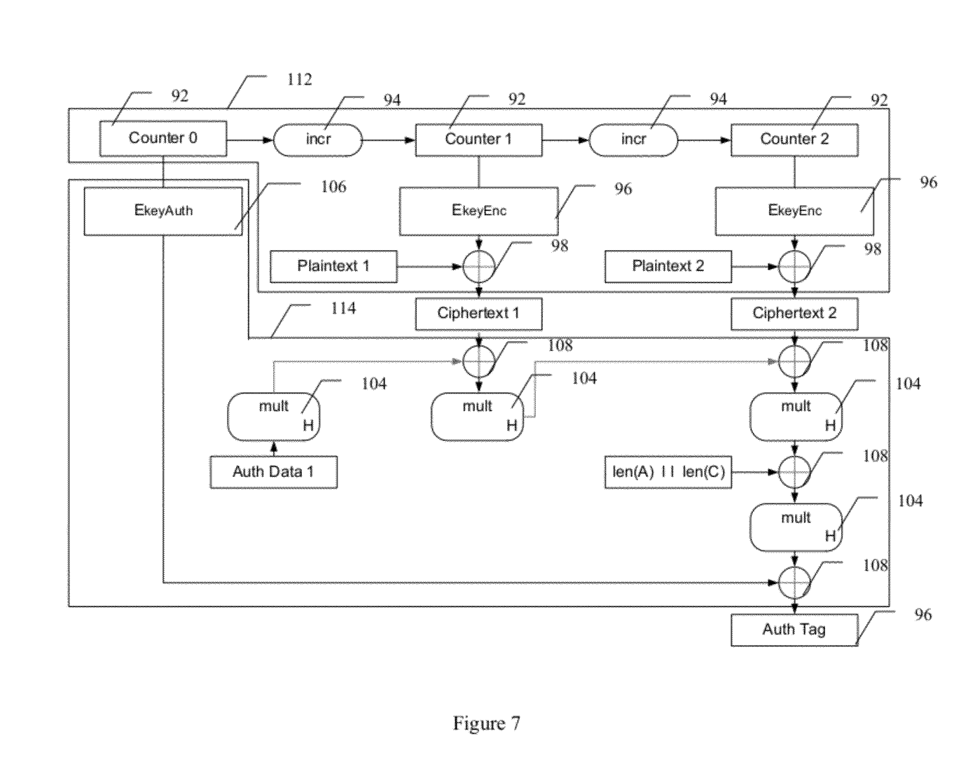

Referring to FIG. 7, an embodiment of the single-pass combined encryption-authentication engine 70 is illustrated in further details. Engine 70 includes a cipher block 112 and an authentication block 114 coupled to each other in parallel, to enable the authentication block 114 to generate the authentication tag 96, using an authentication key, in parallel with the cipher block 112 ciphering a plaintext packet into ciphertext having a number of ciphertext blocks successively generated, using an encryption key.

In various embodiments, cipher block 112 operates in AES counter mode, and authentication block 114 operates in AES-GMAC mode. As illustrated cipher block 112 includes a number of counters 92, incrementors 94, forward blocks 96, and a number Boolean function blocks 98, coupled to each other as shown, whereas authentication block 114 includes a number finite field multipliers 104, a forward block 106 and a number of Boolean function blocks 108.

Forward block 106 operates using the authentication key, while forward blocks 96 operate using the encryption key. The ciphertext blocks are successively generated, each by performing a Boolean function (XOR) on a plaintext block and the output of a corresponding forward block 96. For ease of understanding, only two counter 92, forward block 96, Boolean function 98 chains are shown. Those skill in the art will appreciate in practice, typically, multiple counter 92, forward block 96, Boolean function 98 chains are provided.

The first finite field multiplier 104 takes the authentication data as input. Each subsequent finite field multiplier 104 (except the last one) takes as input, the output of a corresponding Boolean function block performing a Boolean function (XOR) on the output of the preceding finite field multiplier 104 and a corresponding ciphertext block. The last finite field multiplier 104 takes as input, the output of a corresponding Boolean function block performing a Boolean function (XOR) on the output of the preceding finite field multiplier 104 and the concatenated length of the authentication tag and the length of the ciphertext. A Boolean operator is performed on the output of the second to last finite field multiplier 104 and the concatenated length of the authentication tag (len(A)) and the ciphertext (len(C)) to generate the authentication tag to accompany the ciphertext of a packet. In various embodiments, the multiplicand H of each of the finite field multipliers 104 is derived in accordance with AES(authentication key, 0¹²⁸).

Thus, for a recipient device, client or server, a complementary combined decipher (not shown) may first compute the authentication tag for the ciphertext using the authentication key, and determine whether the computed authentication tag matches the authentication tag accompanying the ciphertext. If the computed authentication tag does not match the authentication tag accompanying the ciphertext, the frame or packet may be discarded. And the cipher text is decrypted using the encryption key only if the computed authentication tag matches the accompany authentication tag.

For the intermediate network device, it may decrypt the packet to examine the traffic. However, as noted earlier, without the authentication key, the intermediate network device is unlikely to be able to fabricate or forge messages to spoof the clients/server in the event the intermediate devices are compromised.

Referring to FIG. 6 again, in various embodiments, the hardware solution 99 may be part of a network interface card or part of an integrated MAC within a processor/chipset. As such, the burden of end-to-end security may be removed from the server 16, increasing the possible scale of the network 14 in some embodiments. This allows a seamless employment of the solution, without affecting higher layer protocols/applications, in some cases.

An embodiment may be included as part of a system, e.g. a system having disk storage, such as a laptop computer, a desktop computer, a server, a game console, a set-top box, a media recorder, and so forth.

An embodiment may be implemented by hardware, software, firmware, microcode, or any combination thereof. When implemented in software, firmware, or microcode, the elements of an embodiment are the program code or code segments to perform the necessary tasks. The code may be the actual code that carries out the operations, or code that emulates or simulates the operations. A code segment may represent a procedure, a function, a subprogram, a program, a routine, a subroutine, a module, a software package, a class, or any combination of instructions, data structures, or program statements. A code segment may be coupled to another code segment or a hardware circuit by and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor/machine readable/accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RI') link, etc. The computer data signal may include any signal that can propagate over a transmission medium such as electronic network channels, optical fibers, air electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The term “data” here refers to any type of information that is encoded for machine-readable purposes. Therefore, it may include program, code, data, file, etc.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

1-12. (canceled)

13. An apparatus comprising:
a buffer configured to relay network packets transmitted between clients and servers of a network, each packet having been encrypted and associated with an authentication tag in a single pass by a client or a server using a corresponding set of encryption key and an authentication key of a client-server pair, the encryption and authentication keys having different key values; and
a processing unit coupled to the buffer to decipher and inspect one or more of the packets using the corresponding encryption keys, the processing unit, in terms of the encryption and authentication keys, having only the encryption keys.

14. The apparatus of claim 13 wherein the processing unit is further configured to derive the encryption keys.
